(19) United States
(12) Patent Application Publication
(10) Pub. No.: US 2020/0051058 A1
(43) Pub. Date: Feb. 13, 2020

(54) TRANSACTION RISK ASSESSMENT BASED ON AFFINITY BETWEEN COMBINATIONS OF USERS AND DEVICES

(71) Applicant: CA, Inc., New York, NY (US)

(72) Inventors: Vikrant Nandakumar, Thanisandra (IN); Vijay Shashikant Kulkarni, Kundalahalli (IN); Lyju Rappai Vadassery, Mumbai (IN); Seshadri Venkataraman, Union City, CA (US)

(21) Appl. No.: 16/059,418

(22) Filed: Aug. 9, 2018

(51) Int. Cl. G06Q 20/32; G06Q 20/40; G06Q 20/38; H04L 29/06

(52) U.S. Cl. CPC G06Q 20/3226; H04L 63/0884; G06Q 20/388; G06Q 20/4016

(57) ABSTRACT

A method includes performing by a processor: receiving a transaction request associated with a first user from a first device where a combination of the first user and the first device lacks an authentication history, determining that the first user or the first device is associated with a second user or a second device, determining that the second user or the second device has been authenticated, generating an affinity score that is representative of the association between the first user or the first device and the second user or the second device, and selecting an authentication requirement for acceptance of the transaction request based on the affinity score.

### BACKGROUND

The present disclosure relates to computing systems, and, in particular, to risk assessment and authentication of users and devices.

As payments technology evolves, new types of payment systems and techniques are being used to provide increased protection against counterfeit, account misuse, and other types of fraud. Merchants and financial institutions have the capability to identify devices that are used to perform transactions and label them as high risk then a transaction is associated with fraud, non-payment, late payment, or the like. As a result, when a device is labeled as high risk, future transactions that are initiated using the device may receive enhanced scrutiny, such as more enhanced authentication requirements, lower credit limits, etc., regardless of whether the future transaction is associated with the same user and/or card number as a previous fraudulent transaction. Similarly, when a device is used for a transaction the first time, a user may receive enhanced authentication and/or transaction authorization scrutiny in the form of, for example, multi-factor authentication techniques, access codes received through another device or system, third party authorization, or the like. As the number of successful transactions using a device increases, a risk assessment system of a merchant and/or financial institution may lessen authentication and/or transaction authorization scrutiny based on the device's history.

### SUMMARY

In some embodiments of the inventive subject matter, a method comprises performing by a processor: receiving a transaction request associated with a first user from a first device where a combination of the first user and the first device lacks an authentication history, determining that the first user or the first device is associated with a second user or a second device, determining that the second user or the second device has been authenticated, generating an affinity score that is representative of the association between the first user or the first device and the second user or the second device, and selecting an authentication requirement for acceptance of the transaction request based on the affinity score.

In other embodiments of the inventive subject matter, a system comprises a processor and a memory coupled to the processor and comprising computer readable program code embodied in the memory that is executable by the processor to perform operations comprising: receiving a transaction request associated with a user from a first device where a combination of the user and the first device lacks an authentication history, determining that the first device is associated a second device, determining that the second device has been authenticated, generating an affinity score that is representative of the association between the first device and the second device, and selecting an authentication requirement for acceptance of the transaction request based on the affinity score.

In further embodiments of the inventive subject matter, a computer program product comprises a tangible computer readable storage medium. The tangible computer readable storage medium comprises computer readable program code embodied in the medium that when executed by a processor causes the processor to perform operations comprising: receiving a transaction request associated with a first user from a device where a combination of the first user and the device lacks an authentication history, determining that the first user is associated a second user, determining that the second user has been authenticated, generating an affinity score that is representative of the association between the first user and the second user, and selecting an authentication requirement for acceptance of the transaction request based on the affinity score

Other methods, systems, devices, articles of manufacture, and/or computer program products according to embodiments of the inventive subject matter will be or become apparent to one with skill in the art upon review of the following drawings and detailed description. It is intended that all such additional methods, systems, devices, articles of manufacture, and/or computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a system for assessing transaction risk based on affinity between combinations of users and devices according to some embodiments of the inventive subject matter.

FIG. 2 illustrates a data processing system that may be used to implement the risk assessment server of FIG. 1 in accordance with some embodiments of the inventive subject matter.

FIG. 3 is a block diagram that illustrates a software/hardware architecture for the risk assessment server of FIG. 1 in accordance with some embodiments of the present inventive subject matter.

FIG. 4 is a block diagram that illustrates a mobile device/terminal in accordance with some embodiments of the present inventive subject matter.

FIGS. 5-7 are flowcharts that illustrate operations for assessing transaction risk based on affinity between combinations of users and devices in accordance with some embodiments of the inventive subject matter.

FIG. 8 is a block diagram illustrating the association between affinity scores and authentication requirements in accordance with some embodiments of the inventive subject matter.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it not limited to, a hardware element, firmware component, and/or software component. A data processing system may be configured with one or more data processing facilities.

As used herein, the term “mobile terminal” or “mobile device” may include a satellite or cellular radiotelephone with or without a multi-line display; a Personal Communications System (PCS) terminal that may combine a cellular radiotelephone with data processing, facsimile and data communications capabilities; a PDA or smart phone that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals or mobile devices may also be referred to as “pervasive computing” devices.

Merchants and/or financial institutions, such as banks, credit card companies, and the like, use risk assessment systems when determining whether to approve a transaction that are based on the transaction history of the user and/or the device or system used to initiate the transaction. A mobile terminal that has been used in fraudulent transactions in the past may result in the merchant or financial institution requiring enhanced authentication before allowing the transaction to proceed as compared to a mobile terminal that has a history of successful transactions. Some embodiments of the inventive subject matter arise from a realization that various combinations of users and/or devices may have an affinity with each other that may influence the risk assessment associated with a particular transaction. For example, a child may not have any history purchasing from a particular merchant. However, the merchant detects that the child's transaction is being initiated using the child's parent's phone. Both the child's parent and the parent's phone have a history of successful transactions. As a result, the authentication requirements imposed before allowing the child's transaction to proceed may be reduced or simplified relative to what is customary when interacting with a user for the first time without any transactional history. Thus, embodiments of the inventive subject matter may allow the authentication requirements for a transaction to be better tailored to the actual risk associated with the transaction thereby better matching the processing resources devoted to the authentication to the transactional risk level.

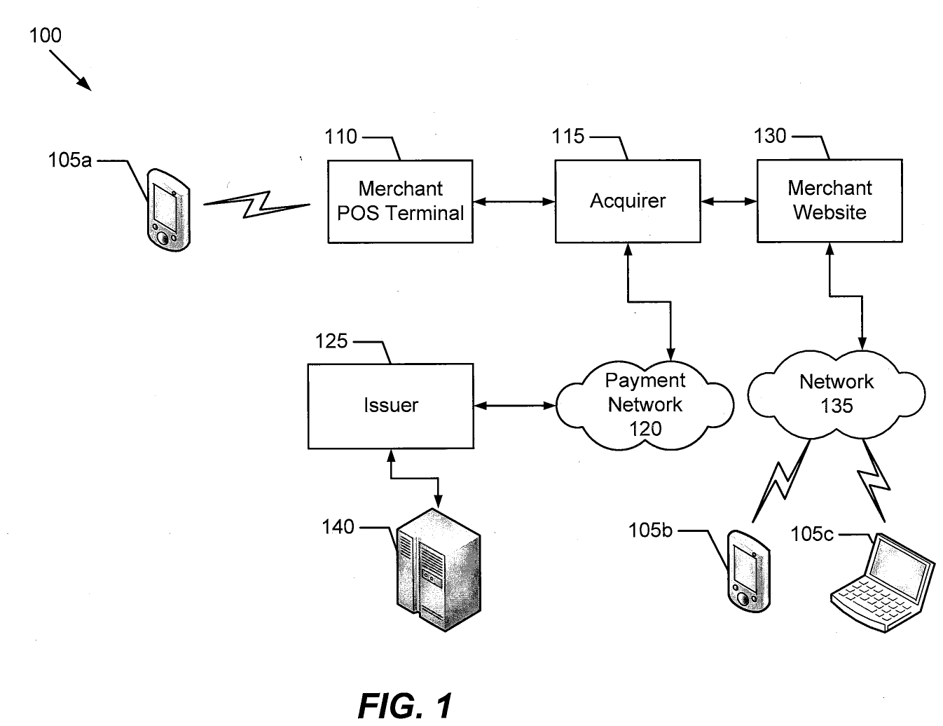

FIG. 1 is a block diagram that illustrates a system for assessing transaction risk based on affinity between combinations of users and devices according to some embodiments of the inventive subject matter. The system 100 comprises a Point Of Sale (POS) terminal 110 that may be operated, for example, in the store of a retailer or merchant. The POS terminal 110 may include a cash register that is managed by an attendant or may be a self-checkout register. The POS terminal 110 may be configured to scan products and read product codes. For example, the POS terminal 110 can be configured to read a UPC product bar code and/or a QR code. In some embodiments, the POS terminal 110 can be configured to scan and read other identifiers (i.e., codes) representative of a product. Once the products are scanned and read, the POS terminal 110 can be configured to generate transaction data and to receive payment associated with the products and/or services listed in the transaction data. The POS terminal 110 may receive payment from a shopper in a variety of ways including, but not limited to, cash, credit card, debit card, gift card, loyalty card, and reward card. The POS terminal 110 may be configured with communication functionality, such as Near Field Communication (NFC) functionality to receive payment information from a customer.

A user or shopper may provide payment information to the POS terminal 110 using a mobile device 105a that may include links to financial accounts thereon and/or data identifying various financial accounts, such as credit card accounts, store credit accounts, debit card accounts, checking accounts, loyalty program accounts, rewards accounts, and the like. The mobile device 105 may also include identification credentials, such as a photo identification, driver's license, passport, insurance card, home and/or work address information, home and/or work telephone numbers, and the like. In some embodiments, the financial information and/or personal identification information may be managed using a digital wallet application residing on the phone or in a cloud server on the Internet or other network.

Similarly, users or shoppers may use mobile devices 105b and/or 105c, such as mobile phones, tablets, laptops, and the like, to purchase items from a merchant's website 130 over the network 135. The merchant's website 130 may be configured to offer users the option of creating an account on their site for making purchases and/or the option to make purchases as a guest by selecting, for example, various payment options, such as credit card, debit card, or other types of online payment systems involving user and/or device authentication. As will be further described below, a financial institution through the merchant's website 130 may impose various authentication requirements based on the user or shopper and/or the history of the mobile device 105b, 105c used to initiate the transaction.

As shown in FIG. 1, the POS terminal 110 and the merchant's website 130 are coupled to an acquirer server/data processing system 115, which represents the merchant's bank or other type of financial institution for processing payments received by the merchant. The acquirer server 115 is coupled to the issuer server/data processing system 125 via a payment network 120. The issuer server 125 may represent any institution providing a source of funds for a shopper's financial transaction including, but not limited to, banks, credit unions, retailers (e.g., store credit accounts/charge cards), mobile payment processors, such as Payfone™, and other financial institutions. It will be understood that the credit issuer may provide funds both through credit accounts and non-credit accounts, including a shopper's savings and/or checking account. The acquirer server 115 is coupled to the issuer server 125 via a payment network 120, which may be operated by an entity associated with the particular instrument used in a financial transaction. Such entities may include, but are not limited to, financial institutions, such as Visa, MasterCard, American Express, Discover Card, and the like who issue credit cards, debit cards, and other types of financial instruments used in financial transactions.

The issuer server 125 is coupled to a risk assessment server 140 that is configured to provide a service to assess the risk associated with a transaction. This risk may be based on the identity of the user or shopper along with the particular device or system used to initiate the transaction. In some embodiments, the risk assessment server 140 may be configured to generate a risk assessment score that that is indicative of the relative risk associated with a requested transaction. According to some embodiments of the inventive subject matter, the risk assessment server 140 may further provide risk assessment based on affinity between various combination of users/shoppers and devices.

The connections between the mobile devices 105a, 105b, 105c, merchant POS terminal 110, acquirer server 115, issuer server 125, and merchant website server 130 may include wireless and/or wireline connections and may be direct or include one or more intervening local area networks, wide area networks, and/or the Internet. The payment network 120 and/or the network 135 may be a global network, such as the Internet or other publicly accessible network. Various elements of the payment network 120 and/or network 135 may be interconnected by a wide area network, a local area network, an Intranet, and/or other private network, which may not be accessible by the general public. Thus, the payment network 120 and/or the network 135 may represent a combination of public and private networks or a virtual private network (VPN). The payment network 120 and/or the network 135 may be a wireless network, a wireline network, or may be a combination of both wireless and wireline networks.

Moreover, although devices 105a, 105b, and 105c are illustrated as being mobile devices or terminals, it will be understood that generally fixed computer devices or systems, such as desktop computers, enterprise computers and terminals, mainframe computer and terminals, and the like may be used to initiate transactions and may be subject to risk assessment according to the embodiments described herein.

Although FIG. 1 illustrates a block diagram for assessing transaction risk based on affinity between combinations of users and devices according to some embodiments of the inventive subject matter, it will be understood that embodiments of the present invention are not limited to such configurations, but are intended to encompass any configuration capable of carrying out the operations described herein.

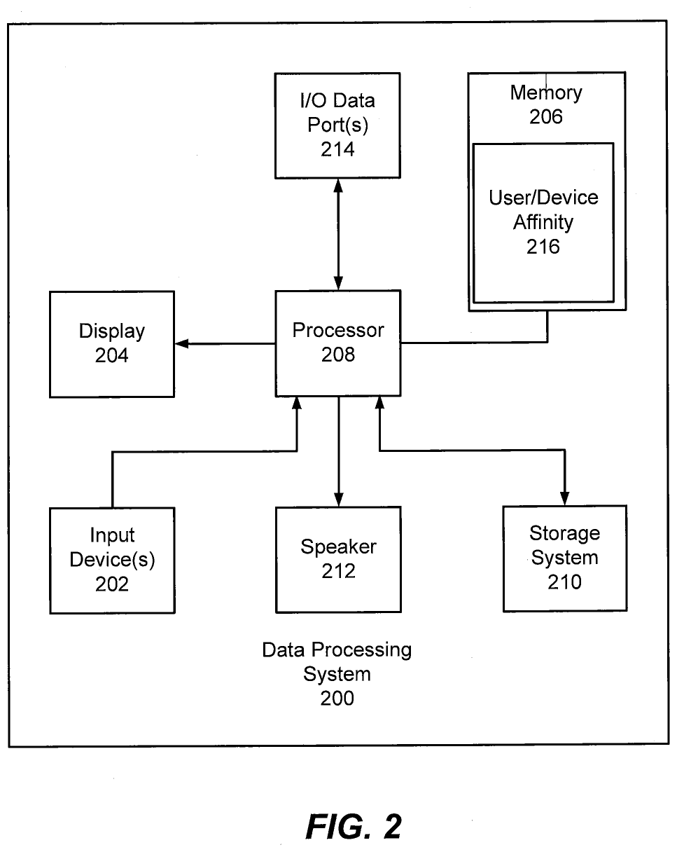

Referring now to FIG. 2, a data processing system 200 that may be used to implement the risk assessment server 140 of FIG. 1, in accordance with some embodiments of the inventive subject matter, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a user/device affinity module 216 that may be configured to provide risk assessment based on affinity between various combination of users and devices according to some embodiments of the inventive subject matter.

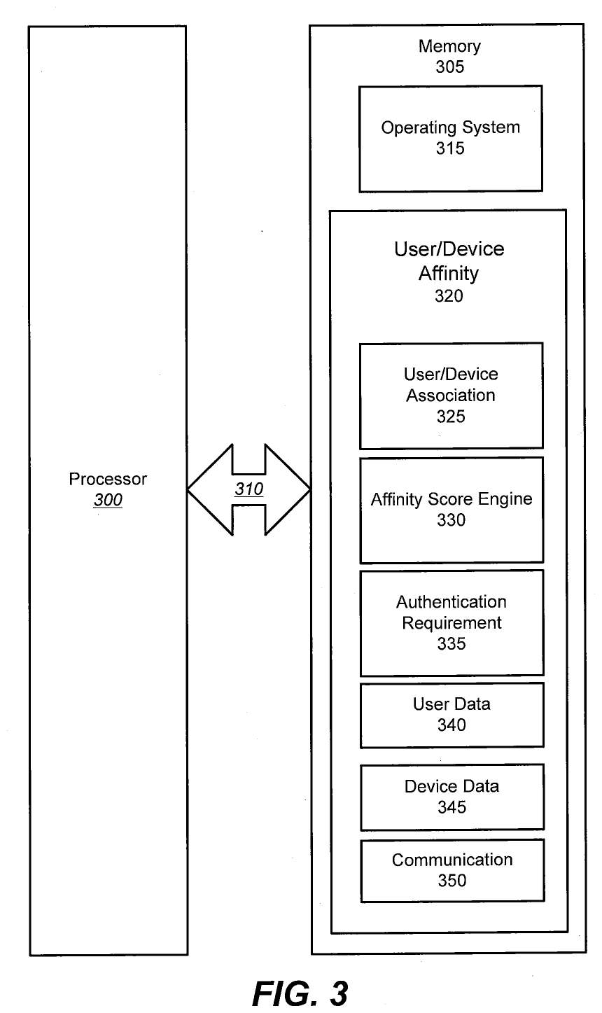

FIG. 3 illustrates a processor 300 and memory 305 that may be used in embodiments of data processing systems, such as the risk assessment server 140 of FIG. 1 and the data processing system 200 of FIG. 2, respectively, for providing risk assessment based on affinity between various combination of users/shoppers and devices in accordance with some embodiments of the inventive subject matter. The processor 300 communicates with the memory 305 via an address/data bus 310. The processor 300 may be, for example, a commercially available or custom microprocessor. The memory 305 is representative of the one or more memory devices containing the software and data used for providing risk assessment based on affinity between various combination of users/shoppers and devices in accordance with some embodiments of the inventive subject matter. The memory 305 may include, but is not limited to, the following types of devices: cache, ROM, PROM, EPROM, EEPROM, flash, SRAM, and DRAM.

As shown in FIG. 3, the memory 305 may contain up to two or more categories of software and/or data: an operating system 315 and a user/device affinity module 320. The operating system 315 generally controls the operation of the data processing system. In particular, the operating system 315 may manage the data processing system's software and/or hardware resources and may coordinate execution of programs by the processor 300. The user/device affinity module 320 includes a user/device association module 325, an affinity score engine module 330, an authentication requirement module 335, a user data module 340, a device data module 345, and a communication module 350.

The user/device association module 325 may be configured to determine an association between a user and another user and/or device and/or between a device and another device and/or user. In accordance with various embodiments of the inventive subject matter, determining that a first user is associated with a second user may be based on a variety of information including, but not limited to, a direct connection on a social media application, an indirect connection on a social media application, a family relationship, a common address, a common phone number, a beneficiary designation, and/or an emergency contact designation. Other types of information may be used to determine whether a first device is associated with second device including, but not limited to, historical connections to WiFi hotspots common to the first device and the second device, historical connections to entities using BLUETOOTH™ that are common to the first device and the second device, contacts in a contact list that are common to the first device and the second device, and/or amounts of time each of the first device and the second device spend in a defined geographic region, respectively. Direct associations between users and devices may be based on historical records of transactions made by users using particular devices. The information used in determining associations between various combinations of users and/or devices may be stored in the user data module 340 and the device data module 345.

The affinity score engine 330 may be configured to generate a quantitative and/or qualitative affinity score or value that is indicative or representative of the association(s) between a user performing a transaction and other user(s) and/or device(s) that have previously performed/initiated transaction(s) and/or a device used to initiate a transaction and other user(s) and/or device(s) that have previously performed/initiated transaction(s). The affinity score engine 330 may cooperate with a transaction risk score engine that generates a quantitative and/or qualitative value that is representative of the overall risk in approving a transaction request. For example, the risk score engine may evaluate a transaction risk based on the credit score of a user, payment history, whether the user is using a recognized device or an unrecognized device, etc. The quantitative and/or qualitative score generated by the affinity score engine 330 may be used to modify the overall transaction risk score generated by a risk score engine and/or may be used alone, or in conjunction with a risk score engine, as a basis for determining what authentication requirements or other safety measures to invoke for a transaction.

The authentication requirement module 335 may be configured to select an authentication requirement for acceptance of a transaction request based on the qualitative and/or quantitative affinity score that is generated by the affinity score engine 330. The authentication requirement module 335 may be further configured to receive authentication input from a user and determine whether the authentication input complies with the authentication requirement. For example, the authentication requirement module 335 may be configured to require only entry of a valid credit card number when the affinity is high between a user performing a transaction and another trusted user and/or trusted device or when the affinity is high between the device a user is using to initiate a transaction and another trusted user and/or device. Conversely, the authentication requirement module 335 may be configured to require multi-factor authentication, third-party authorization, an access code emailed or SMS messaged to a trusted device, or the like for authenticating a user that is not known and has low affinity with other trusted users and/or devices.

The communication module 350 may be configured to facilitate communication between the risk assessment server 140 and the mobile devices 105a, 105b, 105c by way of the issuer server 125 and the payment network 120 and the network 135. In some embodiments, the communication module 350 facilitate obtaining information stored on the mobile devices 105a, 105b, 105c, such as contact information and application information, by way of the merchant POS terminal 110, the merchant website 130, and/or via an application or other information collection means provided by the financial institution allowing users to share information about themselves and their devices directly.

Although FIG. 3 illustrates hardware/software architectures that may be used in data processing systems, such as the risk assessment server 140 of FIG. 1 and the data processing system 200 of FIG. 2, respectively, for providing risk assessment based on affinity between various combination of users/shoppers and devices according to some embodiments of the inventive subject matter, it will be understood that the present invention is not limited to such a configuration but is intended to encompass any configuration capable of carrying out operations described herein.

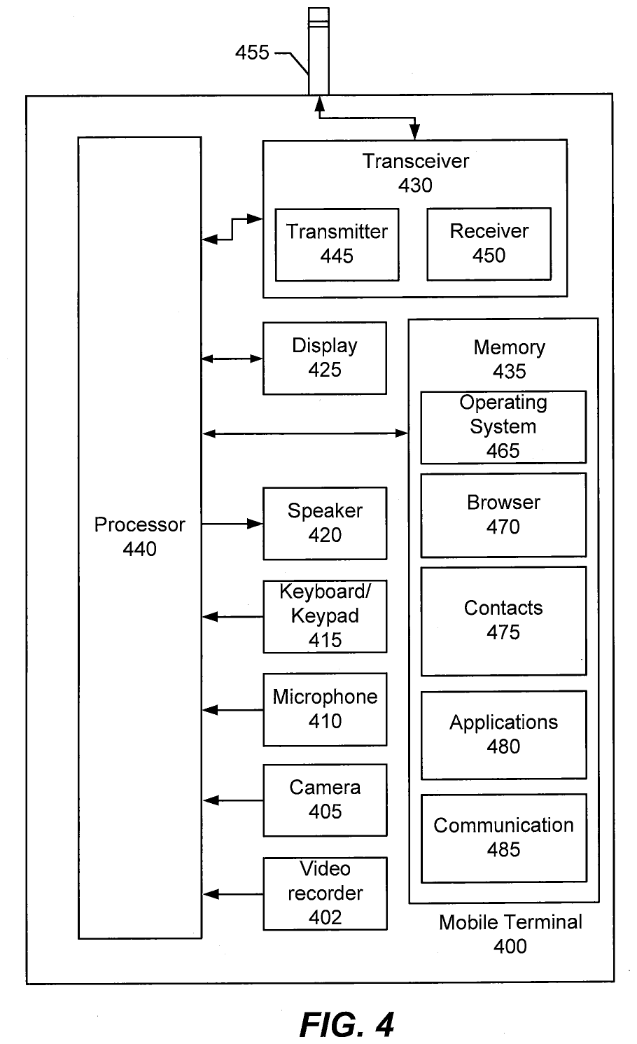

Referring now to FIG. 4, an exemplary mobile terminal 400 that may be used to implement the mobile devices 105a, 105b, 105c of FIG. 1, in accordance with some embodiments of the inventive subject matter, includes a video recorder 402, a camera 405, a microphone 410, a keyboard/keypad 415, a speaker 420, a display 425, a transceiver 430, and a memory 435 that communicate with a processor 440. The transceiver 430 comprises a transmitter circuit 445 and a receiver circuit 450, which respectively transmit outgoing radio frequency signals to base station transceivers and receive incoming radio frequency signals from the base station transceivers via an antenna 455. The radio frequency signals transmitted between the mobile terminal 400 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 400 may be included in many conventional mobile terminals and their functionality is generally known to those skilled in the art.

The processor 440 communicates with the memory 435 via an address/data bus. The processor 440 may be, for example, a commercially available or custom microprocessor. The memory 435 is representative of the one or more memory devices containing the software and data used to provide risk assessment based on affinity between various combinations of users/shoppers and devices in accordance with some embodiments of the present invention. The memory 435 may include, but is not limited to, the following types of devices: cache, ROM, PROM, EPROM, EEPROM, flash, SRAM, and DRAM.

As shown in FIG. 4, the memory 435 may contain up to five or more categories of software and/or data: the operating system 465, a browser module 470, a contacts module 475, an applications module 480, and a communication module 485.

The browser module 470 may be configured to allow the mobile terminal 400 to communicate with Web sites over the Internet, such as the merchant website 130 of FIG. 1. The contacts module 475 may be representative of a list of entities, such as people, companies, businesses, and the like along with their contact information including, for example, phone numbers, email addresses, physical addresses, and the like. The contacts may include additional information about the entities in the list including work phone and address information, biographical information, e.g., school(s) attended, relationship information, e.g., family, friend, business colleague, and the like. The applications module 480 may be representative of various applications that interact with external Websites or servers, that interact with other devices and systems through, for example, Near Field Communication or other short-range wireless technology, and/or that do not have any interaction with external devices or systems. These applications may include, but are not limited to, social media applications, merchant applications, financial institution applications, online shopping applications, and the like. The communication module 485 may be configured to facilitate communication between the mobile devices 105a, 105b, 105c and the merchant POS terminal 110 and/or the merchant website 130. The communication module 485 may also facilitate sharing of information stored thereon, such as contact information from the contacts module 475 and application information from the applications module 480 with the risk assessment server 140 of FIG. 1.

Although FIG. 4 illustrates an example software and hardware architecture that may be used to provide a mobile terminal that can facilitate assessment of transaction risk based on affinity between combinations of users and devices according to some embodiments of the inventive subject matter, it will be understood that embodiments of the present invention are not limited to such a configuration, but are intended to encompass any configuration capable of carrying out the operations described herein.

Computer program code for carrying out operations of data processing systems discussed above with respect to FIGS. 1-4 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the mobile devices 105a, 105b, 105c of FIG. 1, the risk assessment server 140 of FIG. 1, the data processing system 200 of FIG. 2, the hardware/software architecture of FIG. 3, and the mobile terminal of FIG. 4 may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

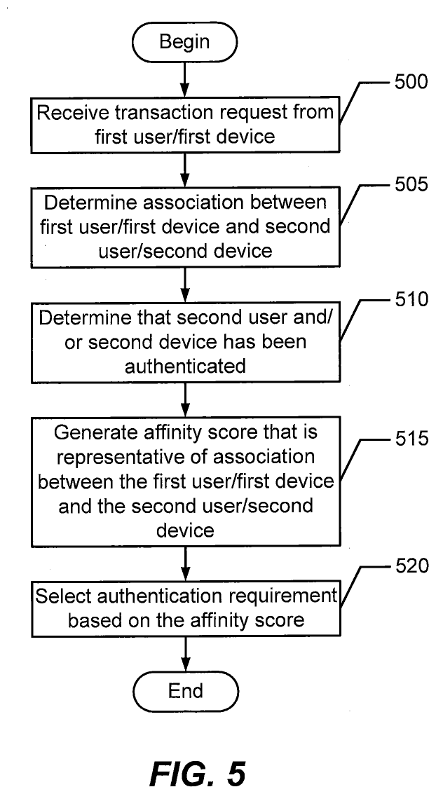

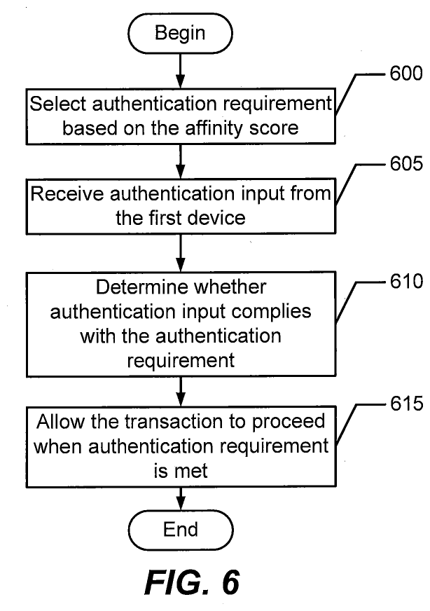

FIGS. 5-7 are flowcharts that illustrate operations for assessing transaction risk based on affinity between combinations of users and devices in accordance with some embodiments of the inventive subject matter. Referring now to FIG. 5, operations begin at block 500 where risk assessment server 140 receives a transaction request from a first device, e.g., one of the mobile devices 105a, 105b, 105c that is associated with a first user. The first device and first user may not have an authentication history with the financial institution associated with the risk assessment server 140. The user/device association module 325 determines an association at block 505 between the first user and one or more second devices and second users and/or an association between the first device and one or more second devices and second users. One or more of these second devices and/or second users may have a transaction history that is accessible to the risk assessment server 140. As a result, at block 510, a determination may be made that one or more of the second users and/or devices has been authenticated. The affinity score engine module 330 generates a qualitative and/or quantitative affinity score at block 515 that is representative of the association between the first user and one or more of the second users and/or devices and/or between the first device and one or more of the second users and/or devices. The authentication requirement module 335 may select an authentication requirement at block 520 based on the affinity score generated at block 515.

In some embodiments, the risk assessment browser 140 may be configured to evaluate the affinity score generated by the affinity score engine 330 and provide the user with an opportunity to comply with selected authentication requirement or may reject the transaction request if the affinity score indicates that the transaction exceeds the financial institution's risk tolerance. For example, operations begin at block 600 where the authentication requirement module 335 may select an authentication requirement based on the affinity score generated at block 515 of FIG. 5. Authentication input may be received from the first device at block 605 and the authentication requirement module 335 may determine at block 610 whether the authentication input complies with the authentication requirement. The transaction may be allowed to proceed when the authentication requirement is met at block 615.

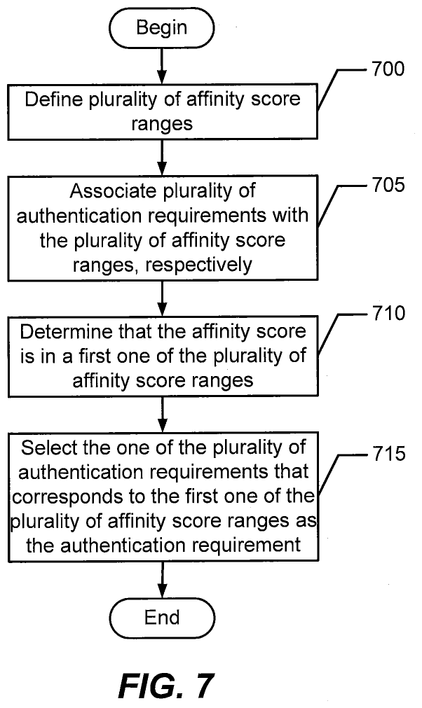

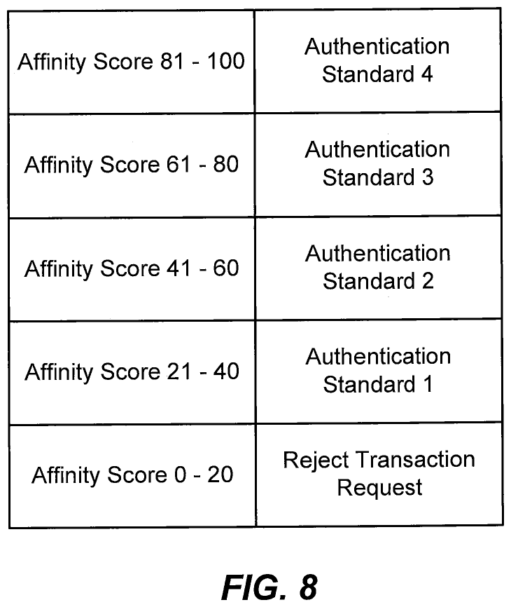

As described above, the authentication requirement module 335 may select an authentication requirement based on the affinity score generated by the affinity score engine module 330. For example, referring to FIG. 7, operations begin at block 700 where a plurality of affinity score ranges are defined. At block 705, authentication requirements may be associated with the affinity score ranges. This is illustrated, for example, in FIG. 8 where an affinity score may range from 0-100 with five ranges defined with each having a range of 20. An affinity score in the lowest category 0-20 corresponds to a rejection of the transaction request without offering the user an opportunity to comply with an authentication requirement. The other four ranges are associated with four different authentication standards 1-4. If a higher affinity score indicates a greater quantity and/or significance in associations between a user and/or device and other users and/or devices that have been previously authenticated, then the authentication standard 4 may impose the least stringent authentication requirement on the user while the authentication standard 1 may impose the most stringent authentication requirement on the user. Thus, operations continue at block 710 where a determination is made that the affinity score falls in one of the plurality of affinity score ranges. The authentication requirement, e.g., authentication standard of FIG. 8, which corresponds to that affinity score range, is then selected as the authentication requirement at block 715 and the user may be given an opportunity to comply with the requirement.

Embodiments of the inventive subject matter may be illustrated by way of example. James uses a new device to perform a transaction with a mobile banking application. Although James is known to the bank, the device James is using to perform the transaction is not known to the bank. As a result, there is concern that someone may be impersonating James to transfer funds from James's account. Julie is James's spouse and has made many transactions with the bank using her phone. Accordingly, both Julie and her phone have been authenticated many times and are known to the bank. Moreover, the risk assessment server used by the bank has collected data from Julie's phone regarding her contacts, social media connections, and geography. The risk assessment server obtains contact information, social media information, and geographic usage information off James's new device and determines that there is significant overlap with similar information on Julie's phone. Moreover, there is a record of frequent calls and emails between James's new device and Julie's phone. As a result, the risk assessment server generates an affinity score indicating a strong affinity between James's new device and Julie's phone. As a result, an authentication requirement is imposed on James that is comparable to a requirement that would be imposed had James been using a device that he had used successfully many times in the past to access his account.

Embodiments of the present inventive subject matter may merchants and financial institutions to tailor authentication requirements for transactions in a way that is a more accurate reflection of the risks associated with the transactions by taking a broader view of an individual's environment beyond just the user name and access device to consider additional factors, such as associations the user may have with other users and/or devices and/or associations between the users device and other users and/or devices. These other users and/or devices may have developed a history of successful transactions such that they have developed a reputation as being relatively low risk. New users and/or new devices may benefit from these associations when performing a transaction as embodiments of the present inventive subject matter may allow the reputations of those users and devices associated with the new user and/or new device to be at least partially transferred to the new user and/or new device. This may allow less stringent authentication requirements to be imposed for a transaction, which may lessen the burden on the processors of computer systems responsible for fraud protection. Conversely, a user and/or device may have associations with other users and/or devices that have a history of fraudulent transactions. In this case, embodiments of the present inventive subject matter may allow very stringent authentication procedures to be imposed on the user and/or device before a transaction is authorized, the transaction may be rejected automatically without providing the user to authenticate, and/or security authorities may be notified as a potential thief may be using a new device or may be impersonating a trusted customer in an attempt to commit fraud.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

That which is claimed:

1. A method, comprising:
performing by a processor:
receiving a transaction request associated with a first user from a first device where a combination of the first user and the first device lacks an authentication history;
determining that the first user or the first device is associated with a second user or a second device;
determining that the second user or the second device has been authenticated;
generating an affinity score that is representative of the association between the first user or the first device and the second user or the second device; and
selecting an authentication requirement for acceptance of the transaction request based on the affinity score.

2. The method of claim 1, wherein determining that the second user or the second device has been authenticated comprises:
determining that the second user has been authenticated; and
wherein determining that the first user or the first device is associated with the second user or the second device comprises:
determining that the first user is associated with the second user.

3. The method of claim 2, wherein determining that the first user is associated with the second user comprises:
determining that the first user is associated with the second user based on a direct connection on a social media application, an indirect connection on a social media application, a family relationship, a common address, a common phone number, a beneficiary designation, or an emergency contact designation.

4. The method of claim 2, wherein determining that the second user or the second device has been authenticated further comprises:
determining that the second device has been authenticated.

5. The method of claim 4, wherein the first device and the second device are a same device.

6. The method of claim 1, wherein determining that the second user or the second device has been authenticated comprises:
determining that the second device has been authenticated; and
wherein determining that the first user or the first device is associated with the second user or the second device comprises:
determining that the first device is associated with the second device.

7. The method of claim 6, wherein determining that the first device is associated with the second device comprises:
determining that the first device is associated with the second device based on historical connections to WiFi hotspots common to the first device and the second device, historical connections to entities using BLUETOOTH™ that are common to the first device and the second device, contacts in a contact list that are common to the first device and the second device, or amounts of time each of the first device and the second device spend in a defined geographic region, respectively.

8. The method of claim 6, wherein determining that the second user or the second device has been authenticated further comprises:
determining that the second user has been authenticated.

9. The method of claim 8, wherein the first user and the second user are a same user

10. The method of claim 1, wherein the method further comprises:
receiving authentication input from the first device responsive to selecting the authentication requirement;
determining whether the authentication input complies with the authentication requirement; and
allowing the transaction to proceed responsive to determining that the authentication input complies with the authentication requirement.

11. The method of claim 10, further comprising:
defining a plurality of affinity score ranges; and
associating a plurality of authentication requirements with the plurality of affinity score ranges, respectively;
wherein selecting the authentication requirement comprises:
determining that the affinity score is in a first one of the plurality of affinity score ranges; and
selecting one of the plurality of authentication requirements corresponding to the first one of the plurality of affinity score ranges as the authentication requirement; and
wherein receiving the authentication input responsive to selecting the authentication requirement comprises receiving the authentication input responsive to selecting the one of the plurality of authentication requirements corresponding to the first one of the plurality of affinity score ranges.

12. The method of claim 1, further comprising:
defining a plurality of affinity score ranges; and
associating a plurality of authentication requirements with the plurality of affinity score ranges, respectively;
wherein selecting the authentication requirement comprises:
determining that the affinity score is in a first one of the plurality of affinity score ranges;
rejecting the transaction request responsive to determining that the affinity score is in the second one of the plurality of affinity score ranges.

13. A system, comprising:
a processor; and
a memory coupled to the processor and comprising computer readable program code embodied in the memory that is executable by the processor to perform operations comprising:
receiving a transaction request associated with a user from a first device where a combination of the user and the first device lacks an authentication history;
determining that the first device is associated a second device;
determining that the second device has been authenticated;
generating an affinity score that is representative of the association between the first device and the second device; and
selecting an authentication requirement for acceptance of the transaction request based on the affinity score.

14. The system of claim 13, wherein determining that the first device is associated with the second device comprises:
determining that the first device is associated with the second device based on historical connections to WiFi hotspots common to the first device and the second device, historical connections to entities using BLUETOOTH™ that are common to the first device and the second device, contacts in a contact list that are common to the first device and the second device, or amounts of time each of the first device and the second device spend in a defined geographic region, respectively.

15. The system of claim 14, wherein the operations further comprise:
determining that the user has been authenticated.

16. The method of claim 13, wherein the operations further comprise:
receiving authentication input from the first device responsive to selecting the authentication requirement;
determining whether the authentication input complies with the authentication requirement; and
allowing the transaction to proceed responsive to determining that the authentication input complies with the authentication requirement.

17. The system of claim 16, wherein the operations further comprise:
defining a plurality of affinity score ranges; and
associating a plurality of authentication requirements with the plurality of affinity score ranges, respectively;
wherein selecting the authentication requirement comprises:
determining that the affinity score is in a first one of the plurality of affinity score ranges; and
selecting one of the plurality of authentication requirements corresponding to the first one of the plurality of affinity score ranges as the authentication requirement; and
wherein receiving the authentication input responsive to selecting the authentication requirement comprises receiving the authentication input responsive to selecting the one of the plurality of authentication requirements corresponding to the first one of the plurality of affinity score ranges.

18. The system of claim 13, wherein the operations further comprise:
defining a plurality of affinity score ranges; and
associating a plurality of authentication requirements with the plurality of affinity score ranges, respectively;
wherein selecting the authentication requirement comprises:
determining that the affinity score is in a first one of the plurality of affinity score ranges;
rejecting the transaction request responsive to determining that the affinity score is in the second one of the plurality of affinity score ranges.

19. A computer program product, comprising:
a tangible computer readable storage medium comprising computer readable program code embodied in the medium that when executed by a processor causes the processor to perform operations comprising:
receiving a transaction request associated with a first user from a device where a combination of the first user and the device lacks an authentication history;
determining that the first user is associated a second user;
determining that the second user has been authenticated;
generating an affinity score that is representative of the association between the first user and the second user; and
selecting an authentication requirement for acceptance of the transaction request based on the affinity score.

20. The computer program product of claim 19, wherein the operations further comprise:
receiving authentication input from the first device responsive to selecting the authentication requirement;
determining whether the authentication input complies with the authentication requirement; and
allowing the transaction to proceed responsive to determining that the authentication input complies with the authentication requirement.
